(19) United States
(12) Patent Application Publication
(10) Pub. No.: US 2007/0182047 A1
(43) Pub. Date: Aug. 9, 2007

(54) Processing of cyclic oligomers to form thermoplastic pbt plastics materials

(76) Inventors: Markus Henne, Schaffhausen (CH); Kurt Behre, Osnabruck (DE); Dietmar Rakutt, Cham (CH); Martin Hintermann, Heiden (CH)

Correspondence Address: BACHMAN & LAPOINTE, P.C., 900 CHAPEL STREET, SUITE 1201, NEW HAVEN, CT, 06510, US

(21) Appl. No.: 10/591,111

(22) PCT Filed: Feb. 19, 2005
(86) PCT No.: PCT/EP05/01743

§ 371 Date: Oct. 12, 2006

(30) Foreign Application Priority Data
Mar. 4, 2004 (EP) 04405128.2

(51) Int. Cl. D21J 3/00; B29C 44/04

(52) U.S. Cl. 264/45.1; 264/324

(57) ABSTRACT

A method for producing fiber-reinforced plate material on the basis of a fiber web that contains at least one planar fiber structure and is impregnated with a thermoplastic plastic matrix. The one or more fiber structures are impregnated or coated with a reactive starting material, containing cyclic or macrocylic oligomers of the polyester, and in that the fiber web which contains one or more combined, impregnated or coated fiber structures is coated on one or both sides with a surface layer that contains a polymerized polyester. The fiber web that is coated with said surface layer is pressed in a pressing device to give a plate material, thereby polymerizing the reactive starting material into a plastic matrix that surrounds the fiber structure and that is permanently joined to the surface layer.

### CROSS REFERENCE TO RELATED APPLICATIONS

This case is the U.S. national phase of International Application No. PCT/EP2005/001743 filed Feb. 19, 2005 which claims priority of European Application No. 04405128.2 filed Mar. 4, 2004.

### BACKGROUND OF THE INVENTION

The invention relates to a method for producing fibre-reinforced plastics material articles, containing PBT or a PBT blend, according to the preamble of the independent claims. The invention also relates to fibre-reinforced plastics material articles, containing PBT or a PBT alloy, according to the preamble of the independent claims.

It was previously difficult to process thermoplastic plastics material systems for the purpose of producing fibre-reinforced plastics material articles in the production processes designed to process thermosetting plastic systems, such as RTM methods or prepreg processing. The difficulty in processing thermoplastic plastics material systems lies inter alia in the provision of a suitable reactive starting material, which is not only chemically stable, but can also be converted into a low-viscosity state for further processing.

Thus, for some time, efforts have been made to develop thermoplastic plastics material systems, which can be processed similarly to thermosetting plastics material systems. One known system of this type is based, for example, on a polyamide (PA) such as PA-12 with lactam as the starting material. A further very promising system is based on a polyester, such as polybutylene terephthalate (PBT). The reactive starting material for producing the polyester, for example PBT, is present in the form of so-called cyclic or macrocyclic oligomers, which are mixed with a corresponding polymerisation catalyst. The special feature of this system is that the reactive starting material can be converted into a low-viscosity melt, which makes this suitable for processing by means of an injection method, such as, for example, an LCM method.

LCM means “liquid composite moulding”. In this text, the LCM method or LCM technology is taken to mean a method in which the cavity of a multi-part moulding tool, in particular a two-part moulding tool, is equipped with a single-part or multi-part fibre blank or fibre structure and a thermosetting or thermoplastic plastics material matrix is fed or injected into the cavity of the closed moulding tool and flows through and impregnates the fibre blank forming a fibre composite component and fills the cavity of the moulding tool, and on completion of the mould filling, the fibre composite component is brought to hardening or polymerisation and is then demoulded. Said LCM method obviously also comprises variants with melting cores or permanent cores, such as foamed material cores, which, together with the fibre structures, are inserted into the opened moulding tool.

If a thermosetting plastics material matrix system is processed in an LCM method, this is a resin transfer moulding (RTM) method. The LCM method is therefore understood to be a designation which is superordinate to the RTM method for the above-described injection method, which in addition to thermosetting plastics material matrix systems, also comprises thermoplastic plastics material matrix systems. The RTM method is described in detail for example in, K o̅tte, “Der Resin-Transfer-Molding-Prozess—Analyse eines Harzinjektionsverfahrens”, Verlag TÜV Rheinland, 1991.

However, an RTM method is also frequently referred to in the processing of thermoplastic matrix systems by means of LCM technology.

The low-viscosity properties of said cyclic oligomers are also advantageous, however, for processing in other methods, as the low-viscosity, reactive starting material brings about an optimum saturation or impregnation of the fibres and this is very significant, in particular in the case of plastics material articles with a high fibre content in the form of dense fibre structures.

U.S. Pat. No. 6,369,157 describes, for example, a suitable reactive starting material, which can be processed to form a PBT plastics material or a PBT plastics material alloy. Examples of possible processing methods are the prepreg processes, RTM methods, pultrusion methods, extrusion methods and compression moulding methods.

The object of the present invention is to propose specific methods for processing PBT plastics material systems or the reactive PBT starting materials pertaining thereto on the basis of cyclic oligomers. The present invention also relates to the products resulting therefrom and containing PBT plastics materials.

### SUMMARY OF THE INVENTION

The object is achieved according to the invention by providing a method for producing a fibre-reinforced sheet material made of a fibre web which is impregnated with a thermoplastic plastics material matrix, containing at least one planar fibre structure, characterised in that the fibre structure(s) are impregnated or coated with a reactive starting material containing cyclic or macrocyclic oligomers of the polyester, and the fibre web containing one or more impregnated or coated fibre structures brought together is coated on one or both sides with an outer layer containing a polymerised polyester, and the fibre web which is coated with the outer layer is pressed in a pressing device to form a sheet material, wherein the reactive starting material is polymerised into a plastics material matrix surrounding the fibre structures and permanently connected to the outer layer.

### BRIEF DESCRIPTION OF THE DRAWINGS

The invention will be described in more detail hereinafter by way of example and with reference to the accompanying drawings, in which:

FIG. 1 shows a device for carrying out an outer film method;

FIG. 2 shows a device for producing a multi-layer composite;

FIG. 3 shows a perforated plate of a foamed material extrusion device;

FIG. 4 shows a cross-section of a sandwich element.

### DETAILED DESCRIPTION

### Definitions

Reactive Starting Material:

A reactive starting material according to the following definition comprises, inter alia, cyclic or macrocyclic oligomers of the polyester, in particular of the PBT (called CPBT), which are blended with a polymerisation catalyst. A reactive starting material also comprises blends (alloys) containing the aforementioned materials, which, for example on completion of the polymerisation, produce a PBT blend (PBT plastics material alloy). Said reactive starting materials for producing polyesters or PBT plastics materials are described in more detail in U.S. Pat. No. 6,369,157, the content of which is thus part of the disclosure. Particularly suitable reactive PBT starting materials in the form of cyclic oligomers are produced under the name CBT™ (cyclic butylene terephthalate) from the company Cyclics. The polymerisation catalyst may, for example, be a zinc catalyst or another suitable catalyst.

Polyesters:

Polyesters according to the following definition contain, inter alia, plastics materials such as PET (polyethylene terephthalate) and associated blends and in particular PBT (polybutylene terephthalate) or PBT blends (PBT plastics material alloys).

Fibre Structures:

Fibre structures according to the following definition are planar structures and comprise, inter alia, textile area-measured materials, for example fibre webs, non-wovens, non-mesh forming systems, such as woven fabrics, unidirectional or bidirectional bonded fabrics, plaited fabrics or mats etc., or, for example, mesh-forming systems, such as knits and embroidered structures.

Fibres:

The fibres of the fibre structures are, according to the following definition, for example, long fibres with fibre lengths of, for example 3 to 150 mm or continuous fibres and are processed for example, in the form of rovings to form fibre structures.

The fibres may be glass fibres, aramid fibres, carbon fibres, plastics material fibres, natural fibres or mixtures thereof. Plastics material fibres may, in particular, be polyester fibres, such as, for example, PET, PBT or a PBT blend. With regard to the inorganic fibres, glass fibres are preferably used, as, in contrast to aramid or carbon fibres, they can be separated with relatively little outlay from the plastics material matrix during recycling of the fibre-reinforced plastics material article and glass fibres are also relatively economical.

PBT fibres are distinguished in that owing to the production process, they have a crystalline orientation in the fibre direction, while the matrix has substantially no crystalline orientation between the fibres, i.e. is amorphous.

Sheet:

A sheet according to the following definition means a planar body with a certain flexural rigidity, and a thickness which is small in comparison to the longitudinal and width extent. Said sheets have, for example, a thickness of 0.5 mm or more, preferably 1 mm or more, and in particular 2 mm or more and 10 mm or less, preferably 6 mm or less, and in particular 4 mm or less.

### Outer Layer Method

To produce preimpregnated fibre structures (prepreg), generally fibre mats, until now the fibre structures were saturated (impregnated) with a reactive plastics material matrix or coated with reactive powder, the powder, in particular the heated powder itself having adhesive properties and therefore adhering to the fibre structure.

It is also known to apply the reactive starting material, i.e. the cyclic oligomers, to the fibre structure in film form, an impregnation of the fibre structure taking place, by melting these films, owing to the low-viscosity properties of the reactive starting material in the molten state.

As prepregs are generally adhesive, these are generally provided according to the known technique, with a release layer, in other words a release film on one or both sides. A release layer of this type allows the development of continuously produced prepregs to form a rolled product on so-called coils for interim storage before further processing into fibre-reinforced sheet materials, without these sticking together in the process. On the other hand, the release layers are also significant during further processing as, during production of hardened or polymerised sheet material, they protect the equipment, i.e. the presses or rollers from adhering to the prepregs. After hardening or polymerisation of the prepregs to form a sheet material, also called organic sheet, the release layer is removed. The release layer is thus not a part of the end product here but merely a production aid.

The idea of the present invention is to improve the method for producing and further processing so-called prepreg semi-finished products and, in the broader sense, to improve sheet material made of polyester, such as PET, and in particular, PBT or a PBT blend using a reactive starting material.

For this purpose, in a first step, fibre structures are impregnated and coated with the reactive starting material. The fibre structures can be saturated for this purpose with a liquid, reactive, starting material, for example by means of immersing the fibre structures in a solution bath, wherein the solvent is removed again after the impregnation. Furthermore, the liquid starting material can also be applied by means of spraying, painting, pouring, rolling or doctoring on the fibre structures.

The fibres structures may be coated in an alternative variant with the reactive starting material in powder form or in the form of films, wherein in both cases, the reactive starting material is melted in the course of the production process with impregnation of the fibre structures. If the reactive starting material is applied to the fibre structure in powder form, this can be heated for the purpose of improving the adhesive properties, wherein the powder may even soften or melt. Alternatively, or in combination with this, the fibre structure may be preheated and coated with the powder. The powder coating may take place on a horizontally or vertically traversing fibre web, the powder accordingly being supplied vertically or horizontally to the fibre web. The powder can be supplied here by means of gravitational force and/or by means of a gas or air flow. The gas or air flow is preferably heated, so the powder develops adhesive properties when impinging on the fibre web. Moreover, the powder may also be supplied by means of an electrostatic method.

In said method, two or more layers of fibre structures may also be impregnated or coated as described above and combined to form a multi-ply or multi-layer fibre web.

In a following step, the single-layer or multi-layer fibre web which is impregnated or coated with the reactive starting material is coated on one or both sides with an outer layer in the form of a plastics material film. The plastics material film thus becomes an integral component of the fibre-reinforced sheet material to be produced.

The plastics material film may be made of a thermoplastic or thermosetting plastics material. The outer layer is preferably a polymerised thermoplastic film made of a polyester, such as PET and, in particular, made of a PBT or a PBT blend.

The plastics material film has, for example, a thickness of more than 50 μm, in particular more than 100 μm and less than 2,000 μm, in particular less than 1,000 μm. Owing to the adhesive properties of the reactive starting material, the plastics material film adheres to the impregnated or coated fibre structure. The plastics material film can be applied as a solid film unrolled from a coil or by means of extrusion as a molten, partially solid or solid film.

The outer layer which is applied to the fibre web may also be a fibre-reinforced, web-shaped plastics material with an outer, fibre-free (polymerised) plastics material layer of the above-mentioned composition.

The fibres of the fibre web are preferably made of glass or polyester, such as PET and, in particular PBT or a PBT blend. Owing to the use of polyester fibres, such as PBT fibres, a single-type sheet material is achieved.

The prepregs with applied outer layers are polymerised for further processing under pressure and with the action of heat to form a polyester, such as PET and, in particular, PBT or a PBT blend, the outer layers undergoing an intimate interconnection with the polymerising plastics material matrix of the fibre structure and the outer layers becoming an integral component of the sheet-shaped fibre composite.

The melting or decomposition point of the outer layers is higher here than the polymerisation temperature of the reactive starting material. The outer layer is therefore not impaired during the polymerisation process of the plastics material matrix.

As the melting point of PBT (about 220° C.) is higher than the polymerisation temperature of the reactive starting materials used (about 180 to 190° C.), the outer layers made of PBT films are not disadvantageously impaired by the action of heat during polymerisation of the plastics material matrix. Outer layers made of a polyester, in particular of PBT, moreover produce a single-type plastics material in the composite material according to recycling criteria.

The integral application of outer layers has the additional advantage that a high surface quality of the sheet material is achieved as the outer layers do not contain any fibres.

The outer materials and the plastics material matrix of the fibre web preferably consist, in the polymerised state, of the same plastics material or of closely related plastics materials or plastics material alloys.

In a development of the invention, the outer layers may be dyed and thus already provide the sheet material with the outer, coloured appearance. The dyeing may be such that the fibre-reinforced layer which is arranged under the outer layers is no longer visible. A subsequent colour lacquering step can then optionally be omitted.

The production of the sheet material according to the invention preferably takes place continuously and in line, i.e. in one production line, from the supply of the fibre structure and the starting material to the discharge of the finished sheet material from the press.

For this purpose, one or more fibre structures of the processing device are supplied and optionally brought together, with them being unwound in a web shape from a coil and impregnated or coated in line with a reactive starting material. The impregnation or coating may take place continuously, for example by means of an immersion bath in a feed-through system, a spray device, a powder dispersion device, a device for electrostatic transfer of the powder onto the fibre structure or a device for the supply of a liquid, partially solid or solid film made of a reactive starting material, for example by means of extrusion or from a coil.

A (polymerised) plastics material film is then applied on one or both sides in line on the fibre web which is impregnated or coated with the reactive starting material, the plastics material film either being uncoiled from coils or directly extruded in line and applied to the impregnated or coated fibre web in the liquid, partially solid or solid state.

In a subsequent feed-through press, the composite is polymerised under pressure and/or the action of heat to form a fibre-reinforced sheet material. The pressing process may take place by means of downstream pressing rollers and/or by means of pressing plates. The press device may comprise, for example, floating, hydraulically actuated lower pressing plates, which work against an upper rigid press construction. A feed-through press of this type is operated, for example, with bands, such as PTFE bands or steel bands and allows medium to high feed-throughs as a function of the length of the heating section.

The web-like, polymerised sheet material can then be cut longitudinally and/or transversely to the feed-through direction into individual sheets or strips and be stacked batch-wise. Owing to the outer layers, the equipment is protected during the further processing of the prepreg into sheet material.

In a specific embodiment of the invention, the prepregs are not guided through a press after coating with the outer layers, but wound onto coils or cut to length and stacked batch-wise, with the individual sheets not adhering to one another owing to the release function of the outer layers. The prepregs which are supplied for interim storage in this manner can be further processed at a later point in time to form sheet material as described above or otherwise processed, for example in moulding presses.

The fibre-reinforced sheet material according to the invention is used as flat sheets or as a strip product. The sheet material may also be further processed to form thermally moulded articles, for example by means of deep drawing. Said sheet material in the form of flat sheets can also be further processed to form multi-layer composites, in particular sandwich composites, in which the further layers may comprise foamed materials, metal foils or metal sheets, for example.

The production of such multi-layer composites may also take place continuously and in line, the further layers, such as foamed material layers also being supplied continuously. In a preferred embodiment, the production of the multi-layer composites takes place in line and directly following the production of the fibre-reinforced sheet material. If said sheet material is further processed into multi-layer composites, under some circumstances, it suffices for the prepreg material to merely be coated with an outer layer with a permanent plastics material film as the release layer, while the second surface is coated with a temporary release layer, which is removed again to produce the multi-layer composite. The outer layer containing the permanent plastics material film in this case forms an outer layer of the multi-layer composite, while the second surface is the contact face to further composite layers.

Said sheet material or the composite sheets which are produced therefrom or thermoformed articles are used in transportation, such as road vehicle construction (automobiles, buses, lorries, light vehicles etc.), railway vehicle constructions (railway, tram, municipal railway, magnetic levitation trains), aviation (aircraft construction, space travel), in marine, boat and ship construction and in cable car cabins. Moreover, said sheet material is used in building construction and underground work, interior finishing, and in particular in building services engineering and in the production of sports equipment.

Single-type Plastics Material Articles

The present invention also relates to single-type, fibre-reinforced plastics material articles, hereinafter called single-type plastics material articles, which contain fibres made of polyester, such as PET and in particular PBT or a PBT blend, and a plastics material matrix also made of polyester, such as PET and in particular PBT or a PBT blend. The single-type plastics material articles may, for example, be fibre-reinforced plastics material sheets, which are produced from prepregs which are impregnated or coated with a reactive starting material, which are polymerised under pressure and/or the action of heat to form fibre-reinforced plastic material plates. The fibre structures may be coated, for example with the reactive powdery starting material, or else be saturated with the reactive starting material present in liquid form, optionally in solution. It is also conceivable for the fibre structures to be coated on one or both sides with a film of a reactive starting material, the film being melted in a low-viscosity manner for the purpose of impregnation of the fibres.

The plastics material matrix is polymerised under pressure and the action of heat in a pressing device with the formation of a fibre-reinforced plastics material sheet.

The fibre structures which are equipped with the reactive starting material can also be processed in a moulding tool with the application of pressure and heat and polymerisation of the plastics material matrix to form a moulded single-type plastics material article.

Said sheet material may be produced by the above-described outer film method and furthermore contain a coating on one or both sides with an outer film made of polyester, such as PET and in particular made of a PBT or a PBT blend.

Furthermore, said single-type, fibre-reinforced single component plastics material article may also be a moulded body produced by means of an above-described LCM method. The reactive starting material is expediently fed or injected for this purpose in a moulding tool which is designed with a fibre structure. The fibres of the fibre structure consist of a polyester, such as PET and in particular PBT or a PBT blend.

Single Component Plastics Material Article

A further processing method is distinguished in that the fibre-reinforced plastics material consists completely of a polyester, such as PET, and in particular of a PBT or a PBT blend. To produce said plastics material articles, the reactive starting material is processed to form linear fibres, which are in turn processed to form a polyester, such as PET and in particular PBT or a PBT blend. Alternatively, the fibres may also be produced for this purpose directly from polyester, such as PET and in particular PBT or a PBT blend. The fibres are distinguished in that they have a crystallinity oriented in the fibre direction and therefore have good mechanical properties, such as rigidity and tensile strength. Said fibres are processed in a subsequent processing step to form fibre structures, such as defined above.

In a subsequent method step, at least the surfaces of the individual fibres or rovings are melted or melted on, the molten plastics material binding or bonding the fibres and being hardened with recrystallisation to form a preferably isotropic plastics material matrix arranged between the fibres. This method step is distinguished by the use of pressure and/or heat. A method of this type may be, for example, a hot pressing or hot compaction method.

The result is a compact, self-reinforced plastics material, which contains single-type plastics material fibres embedded in a plastics material matrix. Said plastics material article in this case has similar mechanical properties to plastics material articles reinforced with inorganic fibre structures. Same-type or single-type means here that the two components are made of polyester.

The described polymerised plastics material article is distinguished by its good thermoformability and can be further moulded or finally moulded in downstream forming methods with the use of heat and/or pressure.

Said plastics material articles, hereinafter called single-component plastics material articles, may be produced in the form of sheets or moulded bodies, the sheets preferably being continuously produced in a corresponding pressing device or rolling device, while the moulded bodies are preferably produced piece-wise in correspondingly designed moulding tools, such as moulding presses.

Multi-layer Composite

The subject of the present invention is also a multi-layer composite, containing at least one layer made of an open-cell and/or closed-cell foamed material. The foamed material consists of a polyester, such as PET and in particular PBT or a PBT blend. In a preferred embodiment, at least one further layer of the multi-layer composite contains a plastics material matrix made of a polyester, such as PET, and in particular PBT or a PBT blend. The further layer is preferably a fibre-reinforced plastics material sheet.

Said multi-layer composite with a foamed material layer main contain, for example, layers, in particular outer layers on one or both sides, made of a single-type plastics material article or a single-component plastics material article in sheet form, as described above. Furthermore, said layers may also consist of a sheet material produced according to the above-described outer film method.

The multi-layer composite may, for example, be a sandwich element with a foamed material core made of polyester, such as PET and in particular PBT or a PBT blend, and outer layers on both sides made of fibre-reinforced plastics material sheets with a plastics material matrix made of polyester, such as PET and in particular PBT or a PBT blend.

According to a specific embodiment, to produce said multi-layer composites, a fibre structure which is impregnated or coated with a reactive starting material, a so-called prepreg, is applied in a continuous or discontinuous method (for example a batch process) to a (polymerised) foamed material layer, the prepreg being polymerised with the application of heat and/or pressure to form a reinforcement layer, which undergoes a permanent connection with the foamed material layer, the foamed material layer being a core material.

Owing to the adhesive properties of the reactive starting material, the reinforcement layer can be applied excellently to the foamed material layer. The polymerisation of the matrix material leads to a permanent, strong connection between the reinforcement layer and the foamed material layer.

Multi-layer composites, in particular three-layer sandwich composites may, for example, have overall layer thicknesses of more than 3 mm, preferably more than 5 mm, in particular more than 8 mm and less than 30 cm, preferably less than 20 cm, in particular less than 10 cm.

Foamed Material Extrusion

A further subject of the invention is the continuous production of multi-layer composites, in particular sandwich composites. In a preferably continuous method, fibre-reinforced plastics material sheets are produced with a plastics material matrix from a (polymerised) polyester, such as PET and, in particular PBT or a PBT blend. A foamable starting material which is provided with a blowing agent, made of a (polymerised) polyester, such as PET and in particular PBT or a PBT blend is extruded by means of an extruder or one or more nozzles. The starting material expands on discharge from the extruder opening with relief of pressure to form a flat, foamed plastics material.

In a preferred embodiment of the extrusion step, the starting material is extruded in the form of spaghetti-shaped strands through a perforated plate, the strands expanding on discharge from the extruder opening and mutually adhering or melting to form a planar, foamed plastics material. The starting material may also be extruded through a single slot nozzle.

The foamable starting material may be extruded directly onto the also continuously supplied fibre-reinforced sheet material, so the extruded starting material is bonded to the sheet material and thus undergoes an intimate connection with it.

In a further embodiment of the invention, the foamable (polymerised) starting material is extruded onto the not yet polymerised, or only partially polymerised, sheet material, the reactive starting material undergoing an intimate connection with the extruded-on starting material owing to its adhesive properties. In a subsequent method step, the sheet material is completely polymerised using heat and/or the action of pressure.

The sheet material may, for example, be produced by the above-described outer film method, the sheet material expediently only being coated on one side, i.e. on its free, not further coated surface with an outer layer of the above-described type. The outer layer is, in particular, a plastics material film made of a polyester, such as PET, and in particular PBT, or a PBT blend.

The sheet material may also be present in the form of the above-described single-type plastics material article or one-component plastics material article. According to the last embodiment, a single-type sandwich composite is present.

Hybrid Fibre Structures

In a further application of PBT plastics materials or reactive PBT starting material thereof, a hybrid fibre structure containing reinforcement fibres, such as inorganic fibres, for example glass fibres, carbon fibres or aramid fibres, as well as matrix fibres in the form of plastics material fibres are produced either (a) from a polyester, such as PET, and in particular PBT or a PBT blend or (b) from a reactive starting material such as CBT™. The reinforcement and matrix fibres are preferably processed with one another in as uniform a distribution as possible.

By means of heat and/or the application of pressure, the matrix fibres are melted in a subsequent working step and reshaped to form a plastics material matrix surrounding the reinforcement fibres or penetrating the fibre structure made of reinforcement fibres, while the reinforcement fibres are kept undamaged. The matrix and reinforcement fibres may be interwoven or plaited together to form fibre structures.

The plastics material articles which are produced from hybrid fibre structures may be fibre-reinforced plastics material sheets, which are produced in a press, in particular a feed-through press. Furthermore, said plastics material articles may be moulded bodies, which are moulded in a moulding tool, in particular a pressing tool, using heat and/or the action of pressure.

According to variant (a), said polyester is merely melted to form a plastics material matrix and then hardened again. According to variant (b), the reactive starting material is melted, polymerised and hardened to form a plastics material matrix.

Owing to the low-viscosity properties of the reactive starting material in the molten state according to variant (b), good impregnation of the reinforcement fibres is achieved.

In a specific development of the hybrid fibre structure, the reinforcement fibres may be made of a PBT or a PBT blend and the matrix fibres of the hybrid fibre structure may be made of said reactive PBT starting material. As the (polymerised) PBT or a PBT blend has a higher melting point than the corresponding reactive PBT starting material, the reinforcement fibres are not melted during conversion of the matrix fibres into a plastics material matrix with polymerisation.

Production of Fibre-reinforced Moulded Parts by Means of a Moulding Tool

A further method for processing PBT matrix systems relates to the production of fibre-reinforced moulded bodies by means of moulding tools, hereinafter called compression moulding methods. The moulding tool contains at least two tool parts, which can be brought together to form a closed moulding tool with the formation of a cavity reflecting the outer contour of the moulded body.

In a first embodiment of said method, the cavity of the opened moulding tool is equipped with fibre structures and with a reactive starting material in powder form forming the plastics material matrix, the powder quantity introduced being matched to the size of the moulded part to be produced in such a way that as far as possible no, or absolutely no, excess of matrix material is produced in the following shaping process. The moulding tool is closed, the powdery, reactive starting material being melted with the application of heat and/or pressure and penetrating the fibre structures and impregnating them. At the same time, the polymerisation of the plastics material matrix is started and the consolidation process introduced. The moulded part is practically completely polymerised and hardened. A fibre-reinforced moulded part is produced, made of a PBT, which on reaching its dimensional stability is demoulded and can optionally still be tempered. Instead of PBT, further polyesters, such as PET or a PBT blend or their starting materials can also be processed.

In a specific embodiment of said method, the moulding tool is closed in multiple stages, in particular two stages for the purpose of introducing the shaping process. The closing pressure can then be reduced step-wise, so molten powder material can penetrate continuously into the fibre structures, without the fibre structures being displaced from their provided position or deformed during closure of the moulding tool under maximum pressure. Furthermore, the multi-stage closure of the moulding tool allows the removal of possibly superfluous matrix material from the cavity.

In a further embodiment of said method, the reactive PBT starting material may also be supplied in liquid form into the cavity of the opened moulding tool.

The present method has the advantage that feeding or injecting the matrix material in liquid form in a separate method step by a separate device can be dispensed with and therefore can be produced more economically with a technically simpler device.

Production of Plastics Material Article With a Permanent Foamed Material Core

A further aspect is the production of fibre-reinforced plastics material articles with a foamed material core made of a polyester, such as PET, PBT or a PBT blend by means of a moulding tool. For this purpose, one or more separate foamed material cores are enveloped with reinforcement fibres and placed in the moulding tool.

In a first embodiment variant, a reactive starting material, in particular PBT starting material, is fed into the opened moulding tool using the above-described compression moulding method, in its diverse possible embodiment variants, for example in liquid or powder form.

In a second embodiment variant, a reactive starting material, in particular PBT starting material, is injected in liquid form into the moulding tool in a known LCM process.

The polymerising PBT plastics material matrix undergoes an intimate connection here both with the reinforcement fibres and also with the expediently same-type foamed material core.

Precoating the Moulding Tool

A further aspect of the invention relates to the pre-treatment of the cavity of a moulding tool in an LCM or compression moulding method. The cavity is coated with a reactive starting material, with the latter polymerising in the actual shaping process with the formation of the surface of the plastics material article into a polyester, PET, and, in particular, a PBT or a PBT blend.

The coating may be applied in powder form to the preferably preheated cavity wall of the moulding tool, the powder coating being melted in a sintering process to form a thin film. The coating may also be applied in liquid form, for example sprayed on or brushed on. Furthermore, the coating may also be applied as a solid film. The film can be placed on the contour of the cavity wall with softening or melting (for example by heating). Furthermore, the film can also be applied to the cavity wall by means of pressure or a vacuum or in general by means of mechanical means.

It is also conceivable to apply, instead of the reactive starting material, a (polymerised) polyester such as PET and, in particular, a PBT or a PBT blend in one of the manners mentioned above, to the wall of the tool cavity.

The coating in polymerised form preferably consists of the same or a similar plastics material composition as the plastics material matrix of the finished moulded part. The coating may, for example, be more than 10 μm, preferably more than 100 μm, in particular more than 500 μm and less than 5 mm, preferably less than 3 mm, in particular less than 2 mm.

Prior to application of said coating, the tool mould can moreover be coated with a suitable release film, which facilitates demoulding of the hardened plastics material article.

The aim of said coating with a plastics material is to produce a fibre-reinforced plastics material with a surface of high quality. The high surface quality stems inter alia from the fact that the coating contains no reinforcement fibres.

FIG. 1 shows a device for producing fibre-reinforced sheet material from a polyester. A continuously supplied web-shaped fibre structure 1 is coated by means of a powder coating device 3 with a reactive starting material in powder form 2. The powder which is applied to the fibre structure may be heated for the purpose of improving the adhesion properties. As an alternative to this, the fibre structure can be preheated and coated with the powder. Subsequently, outer layers in the form of polyester films 4a, 4b are continuously supplied on both sides and applied to the free surfaces of the coated fibre structures. In a feed-through press 5, the reactive starting material is polymerised with the formation of a plastics material matrix and with intimate connection to the outer layers. The hardened sheet material, after leaving the feed-through press 5 on a roll conveyor 8, is supplied to a cutting or sawing device 6 and cut to length into individual sheets 7.

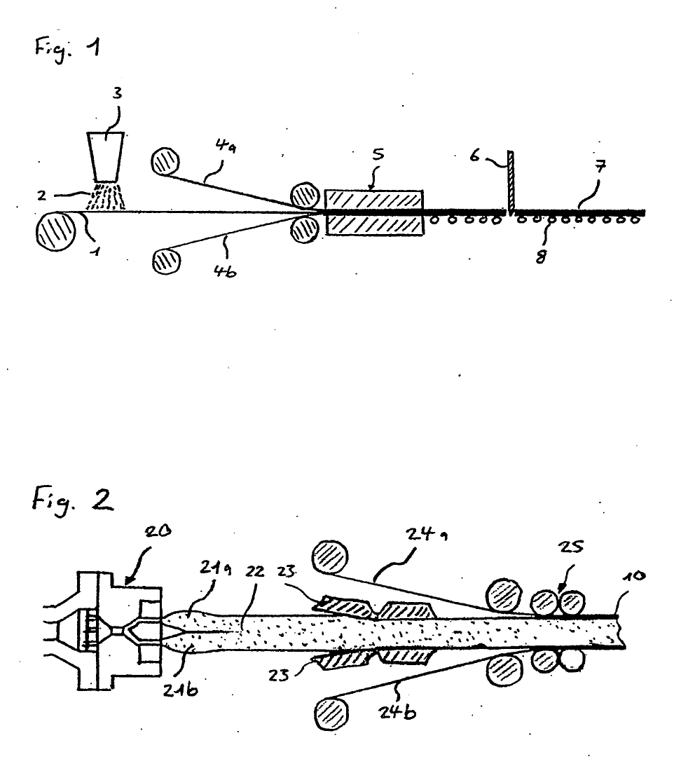

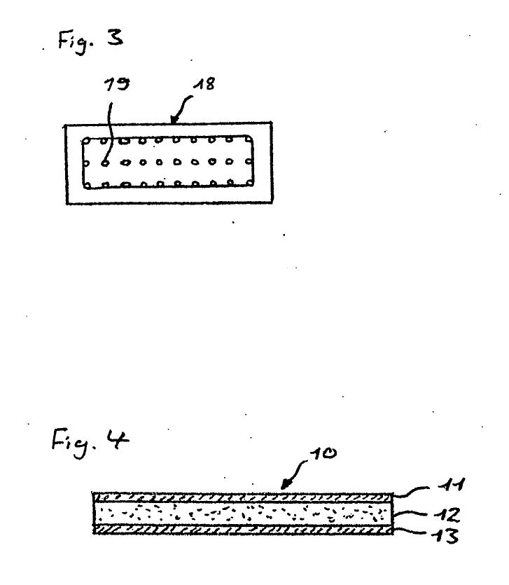

FIG. 2 shows the production of a sandwich composite, strand-shaped polyester 21a, 21b provided with a blowing agent being extruded through the openings 19 of a perforated plate 18 (FIG. 3) of an extrusion device 1. The extruded strands 21a, 21b expand after discharge from the perforated plate 18 and mutually bond to form a sheet-shaped foamed material body 22. The still soft foamed material body 22 is brought in an adjusting device 23 into the desired thickness and width mass. Subsequently, web-shaped fibre structures 24a, 24b which are impregnated or coated with a reactive starting material are supplied and applied to the free surfaces of the foamed material body 22. The layer composite is then pressed in a pressing or rolling device 25 with polymerisation of the reactive starting material to form a plastics material matrix and, with intimate connection thereof to the surface of the foamed material body 22, pressed to form a sandwich composite. The sandwich composite is then cut to length on a cutting or sawing device (not shown) into individual sandwich sheets 10. Said sandwich sheet 10 (FIG. 4) consists of a polyester foamed material core 12 and two outer layers 11, 13 arranged on both sides made of a fibre-reinforced PBT plastics material.

1. Method for producing a fibre-reinforced sheet material made of a fibre web which is impregnated with a thermoplastic plastics material matrix, containing at least one planar fibre structure, comprising the steps of impregnating or coating at least one fibre structure with a reactive starting material containing cyclic or macrocyclic oligomers of the polyester, and a fibre web containing one or more impregnated or coated fibre structures brought together is coated on one or both sides with an outer layer containing a polymerised polyester, and the fibre web which is coated with the outer layer is pressed in a pressing device to form a sheet material, wherein the reactive starting material is polymerised into a plastics material matrix surrounding the fibre structures and permanently connected to the outer layer.

2. Method according to claim 1, wherein the reactive starting material contains cyclic oligomers of the PBT (CPBT) blended with a polymerisation catalyst.

3. Method according to claim 2, wherein the outer layer is selected from the group consisting of PET, PBT, PBT plastics material alloy, and mixtures thereof.

4. Method according to claim 1, wherein the outer layer is applied to the fibre web in the form of a pure plastics material film.

5. Method according to claim 1, wherein the outer layer is extruded onto the fibre web in a solid, partially solid or liquid form.

6. Method according to claim 1, wherein the outer layer is applied to the fibre web as a fibre-reinforced, web-shaped plastics material with an outer, exposed and fibre-free plastics material layer made of a polyester, is selected from the group consisting of PET, PBT, PBT blend.

7. Method according to PBT claim 1, wherein the sheet material is produced continuously and in line with the supply of web-shaped fibre structures.

8. Method according to claim 1, wherein the fibre structure of the fibre web are impregnated or coated in line with the reactive starting material or are supplied already preimpregnated or precoated to the equipment.

9. Method according to claim 1, wherein the fibre structure which is impregnated or coated with the reactive starting material are supplied continuously and in a web-shaped and brought together to form a fibre web, and the fibre web is coated in line on one or both sides with an outer layer, preferably in the form of a film or an extruded film.

10. Method according to claim 1, wherein the fibre web which is coated on one or both sides with an outer layer is pressed in line in a feed-through press to form a sheet material.

11. Method for producing a fibre-reinforced plastics material article containing a fibre structure embedded in a plastics material matrix made of a polyester, wherein the cavity of a moulding tool is equipped at least with a fibre structure and a reactive starting material containing cyclic or macrocyclic oligomers of the polyester blended with a polymerisation catalyst, and the moulding tool is closed and the reactive starting material is polymerised to form a thermoplastic plastics material matrix with the application of pressure and/or heat, characterised in that the wall of the tool cavity is coated with a film made of a reactive starting material containing cyclic or macrocyclic oligomers of the polyester or a polymerised polyester, such as PET, PBT, PBT blend.

12. Method for producing a multi-layer composite containing at least one layer made of a foamed material and an outer layer connected thereto made of a fibre-reinforced sheet material, characterised in that both the foamed material and the sheet material contain a plastics material matrix made of a polyester and, to produce the multi-layer composite, a single-layer or multi-layer fibre web which is impregnated or coated with a reactive starting material containing cyclic or macrocyclic oligomers of the polyester blended with a polymerisation catalyst is connected to a foamed material layer made of a polymerised polyester to form a laminate, and the reactive starting material is polymerised, with formation of the plastics material matrix of the sheet material and with an intimate connection to the foamed material layer, to form a polyester.

13. Method according to claim 12, wherein a starting material which is loaded with a blowing agent is extruded by means of an extruder on the impregnated or coated fibre web and is expanded with relief of pressure to form a foamed material layer, which is brought together with the impregnated or coated fibre web and is connected thereto.

14. Method according to claim 13, wherein the starting material is extruded through a perforated plate in the form of individual strands which on discharge expand to form a foamed material and mutually adhere to form a foamed material layer.

15. Method according to any one of claims 11 to 13, wherein the foamed material layer is coated on either side with a sheet material.

16. Method for producing a multi-layer composite containing at least one layer made of a foamed material and an outer layer connected thereto made of a fibre-reinforced sheet material, characterised in that both the foamed material and the sheet material contain a plastics material matrix made of a polyester and, to produce the multi-layer composite, a starting material which is loaded with a blowing agent is extruded on the sheet material, which expands with relief of pressure to form a foamed material layer and is brought together with the sheet material to form a multi-layer composite.

17. Method according to claim 16, wherein the starting material is extruded through a perforated plate in the form of individual strands, which, on discharge, expand to form a foamed material and mutually adhere to form a foamed material layer.

18. Method according to either of claims 16 or 17, wherein the foamed material layer is coated on either side with a sheet material.

19. Method for producing a fibre-reinforced plastics material article, characterised in that both the reinforcement fibres of the fibre structure and the plastics material matrix consist of a polyester, the polyester fibres being processed with directed crystallinity to form a fibre structure and the fibre structure being processed to form a fibre reinforced plastics material article forming a plastics material matrix, in that the surfaces of the fibres are melted and hardened with the formation of an isotropic plastics material matrix surrounding the non-molten part of the fibres.

20. Method according to claim 19, wherein the plastics material article is produced by a hot pressing method.
